(19) United States
(12) Patent Application Publication
(10) Pub. No.: US 2010/0287232 A1
(43) Pub. Date: Nov. 11, 2010

(54) METHODS AND APPARATUS FOR EFFICIENT DISTRIBUTION OF IMAGE DATA

(75) Inventor: John Huffman, Portland, CA (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/747,659

(22) PCT Filed: Dec. 10, 2008
(86) PCT No.: PCT/IB08/55198

§ 371 Date: Jul. 26, 2010

Related U.S. Application Data
(60) Provisional application No. 61/016,058, filed on Dec. 21, 2007.

(51) Int. Cl. G06F 15/16

(52) U.S. Cl. 709/203; 709/247

(57) ABSTRACT

A system efficiently transfers source data from a server to at least one client. A compressed hierarchical representation, which may be used to reconstitute a “visually lossless” version of the image data, is stored at the server. The compressed hierarchical representation is decomposed from the image data using a wavelet transform with floating point kernels, to generate coefficients. The server also stores residual data that permits reconstructing the full fidelity version of the image data from the visually lossless version. The client requests compressed coefficients to reconstruct a visually lossless version of portions of the image data, and the server transfers compressed coefficients specified in the request. To generate a full fidelity image, the client upgrades the visually lossless version of the image to a full fidelity image using the residual data.

The present application is directed toward the field of image transfer over a network, and more particularly towards techniques for efficient transfer of source data, such as medical images, between a server and a client.

It has become more common for images to be stored, distributed, and viewed in digital form using computer technology. In the medical field, Picture Archival and Communication Systems or PACS have been in widespread use. In a typical PACS application, image data obtained by imaging equipment, such as CT scanners or MRI scanners, is stored in the form of computer data files. The size of a data file for an image varies depending on the size and resolution of the image. For example, a typical image file for a diagnostic-quality chest X-ray is on the order of 10 megabytes (MB). The image data files are usually formatted in a “standard” or widely accepted format. In the medical field, one widely used image format is known as DICOM. The DICOM image data files are distributed over computer networks to specialized viewing stations capable of converting the image data to high-resolution images on a display.

In medical imaging applications, images must be displayed at high resolution so that image details having potential diagnostic significance are visible. Also, in medical imaging applications, concurrent viewing of multiple images, captured over time, is desirable in order to enable the detection of changes that occur over a time period. The need for high resolution and multiple views translates into a need for high network bandwidth, large storage capacity, and significant processing power at the viewing stations. The traditional digitally encoded medical images, used in medical applications, usually require powerful and expensive computer systems to archive, distribute, manipulate, and display the medical images. Consequently, many current imaging systems are very expensive.

A technique for efficiently distributing large images over a network, such as medical images, has been developed by Dr. Paul Chang, M.D., and Carlos Bentancourt at the University of Pittsburgh. This technique operates in a client-server environment to deliver image data from the server to the client, as the image data is needed at the client (i.e., a just in time data delivery mechanism). To implement this just in time data delivery mechanism, a dynamic transfer syntax generates a flexible hierarchical representation of an image for storage at the server. The hierarchical representation consists of coefficients produced by a wavelet transform which can be used at the server to obtain image data from a particular area of an image. The transform coefficients preserve the data corresponding to a particular area of the image. To view portions of the image at the client, the client issues requests to the server for transform data that includes coefficient coordinates to identify coefficients in the hierarchical representation. The server provides the requested transform data to the client. The client then reconstructs the portion of the image from a combination of data already locally cached, if necessary, and the provided transform data. A complete description of the dynamic transfer syntax is contained in U.S. Pat. No. 6,711,297 entitled “Methods and Apparatus for Dynamic Transfer of Image Data”, inventors Paul Joseph Chang and Carlos Bentancourt, issued Mar. 23, 2004, which is expressly incorporated herein by reference.

In one embodiment of the system of the Chang '297 patent described above, the wavelet transform uses fixed point kernels with integer coefficient results in order to achieve lossless data presentation. However, this limitation to lossless compression generally precludes compression ratios of greater than 2 to 3 to 1 for image data. In some cases, the ability to obtain greater compression ratios is not necessary if the application has adequate bandwidth. However, in other applications, such as teleradiology applications, it is desirable to achieve compression ratios beyond those ratios generated with purely lossless compression. Another application class where this capability is useful is when the data sets are so large as to make transferring the entire lossless data set impractical (such as very large CT data sets—with thousands of images). It is desirable to increase compression ratios for limited bandwidth sites while preserving the ability to recover the original lossless data.

The present application discloses a system which efficiently transfers source data from a server to at least one client.

In one exemplary embodiment, the source data is decomposed into a hierarchical representation consisting of coefficients. The coefficients are quantized and compressed to form a compressed hierarchical representation, consisting of compressed coefficients. The compressed hierarchical representation may be used to reconstitute a “visually lossless” version of the source data for display at the client.

In order to reconstitute a visually lossless version of the source data at the client, the client requests compressed coefficients from the server, which has access to the compressed hierarchical representation. In response to the client request, the server transfers the compressed coefficients specified in the request. The client decompresses the compressed coefficients, and performs an inverse wavelet transform to generate the visually lossless version of the source data.

The full fidelity or completely lossless version of the source data can be reconstructed from the visually lossless version of the source data combined with residual data. An inverse wavelet transform is performed on the compressed coefficients to generate inverted visually lossless data and the residual data is generated from a difference between the inverted visually lossless data and the original source data. The generated residual data is stored in a partitioned and compressed format augmenting the visually lossless hierarchical representation.

To generate a full fidelity or completely lossless image, the client requests from the server residual data that corresponds to the visually lossless portion. The server has access to the generated residual data. The server transmits the residual data to the client, and the client uses the received residual data to upgrade the visually lossless version of the source data to a full fidelity or completely lossless version of the source data.

The compressed hierarchical representation and the residual data are optionally organized into partitions. For this option, the client requests and the server responses correspond to the respective partitions that organize the compressed hierarchical representation and the residual data.

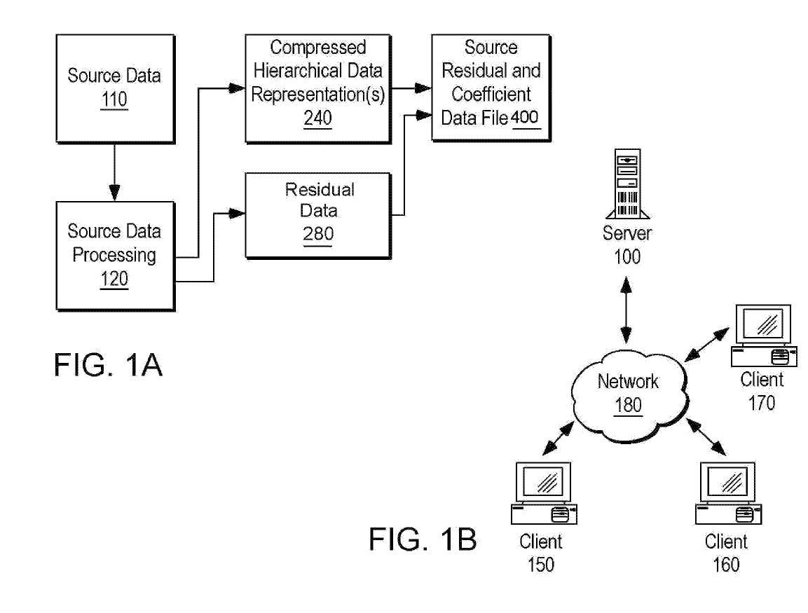

FIG. 1A is a block diagram illustrating one embodiment for processing source data.

FIG. 1B is a diagram of the client-server architecture for processing source data.

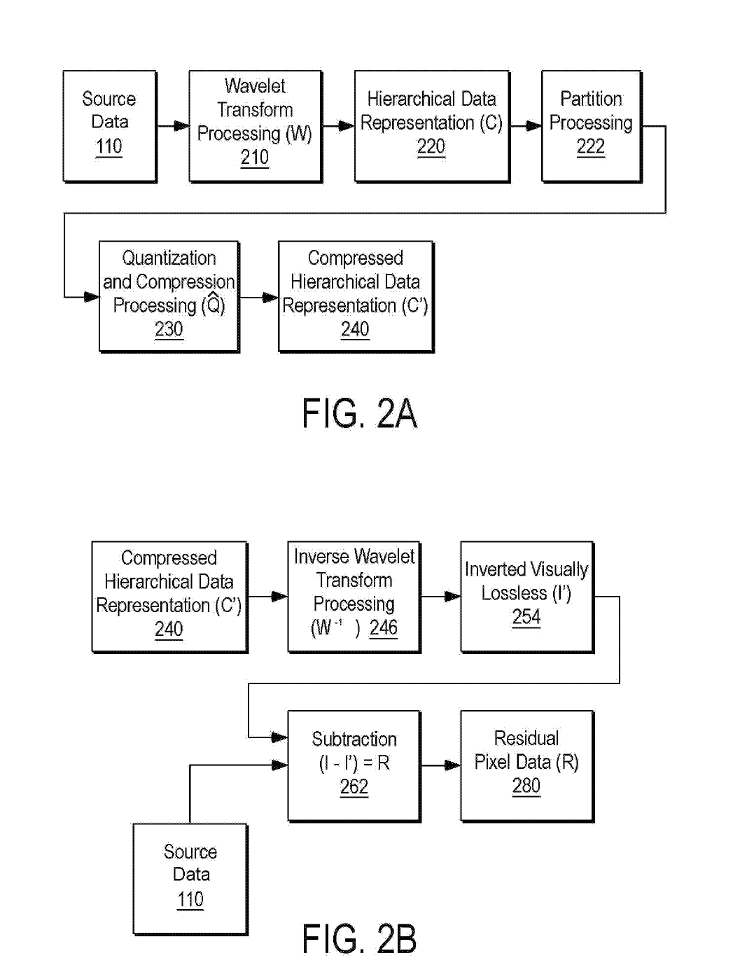

FIG. 2A illustrates one embodiment for generating compressed hierarchical data representations.

FIG. 2B illustrates one embodiment for generating residual pixel data.

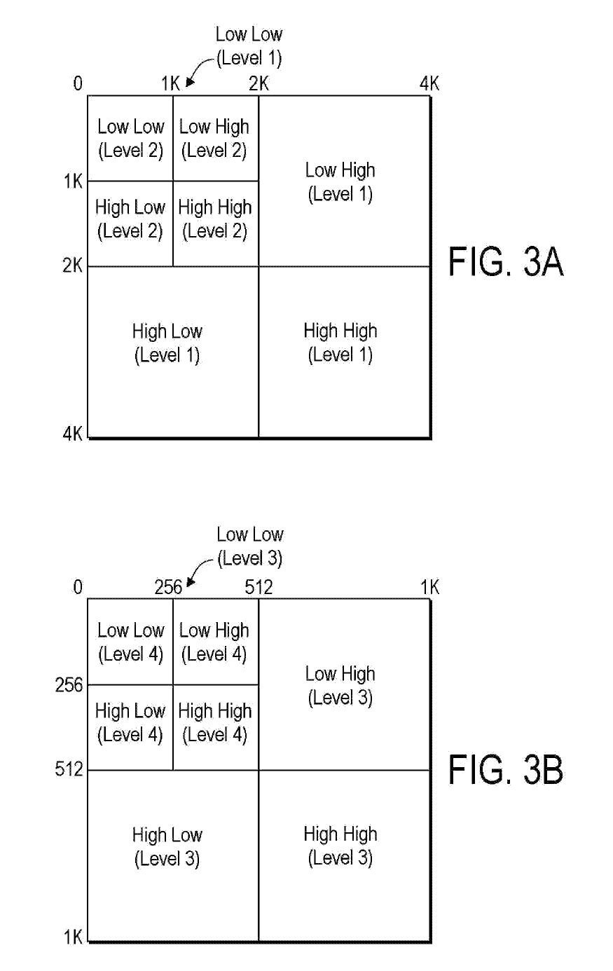

FIG. 3A illustrates an example of a hierarchical data structure.

FIG. 3B illustrates level three and level four decompositions for the 4K×4K source image of FIG. 3A.

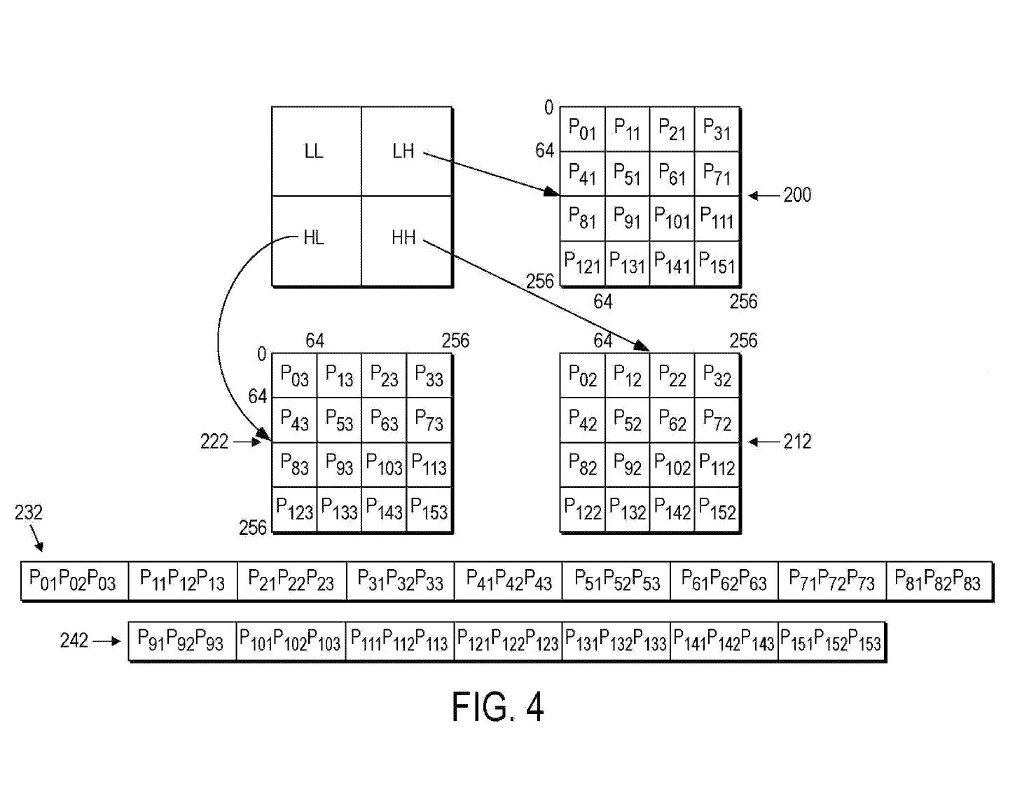

FIG. 4 illustrates organizing level of a hierarchical data structure of coefficients in partitions.

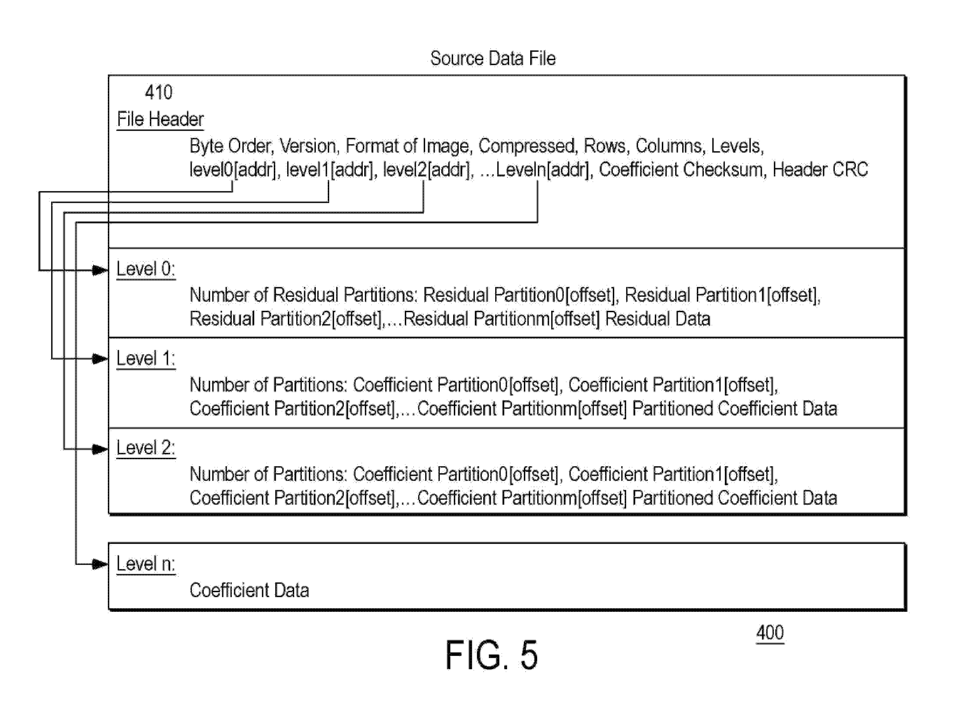

FIG. 5 illustrates one embodiment for a source data file.

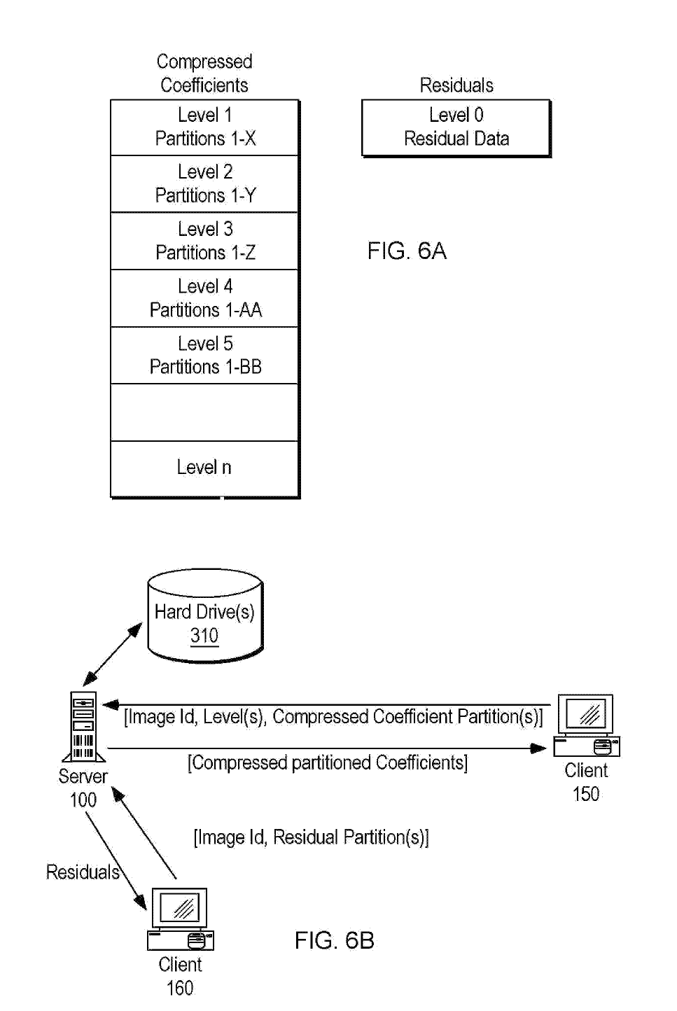

FIG. 6A illustrates a compressed hierarchical representation and residual data stored on a hard disk of a server.

FIG. 6B is a block diagram illustrating one embodiment for implementing the compression techniques in a client-server environment.

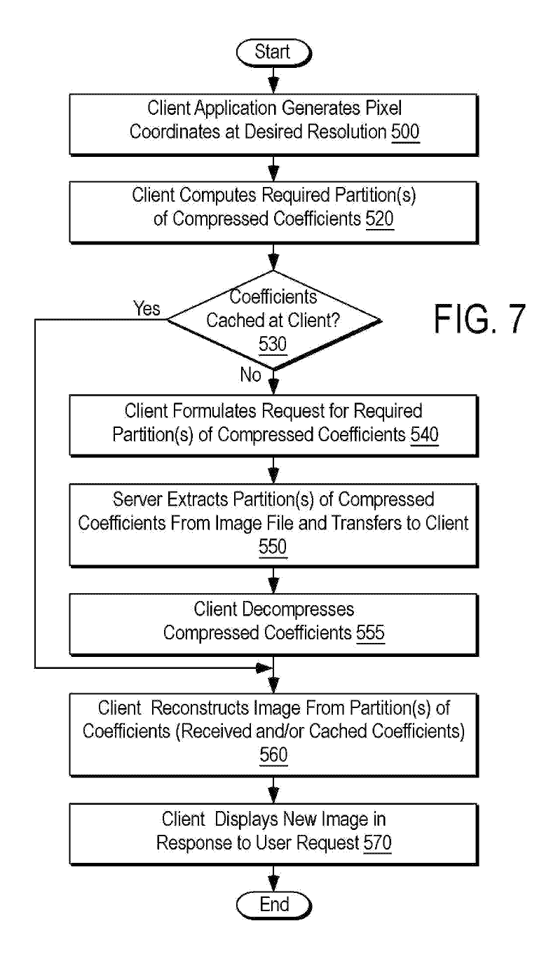

FIG. 7 is a flow diagram illustrating one embodiment for processing client requests for partitions of compressed coefficients.

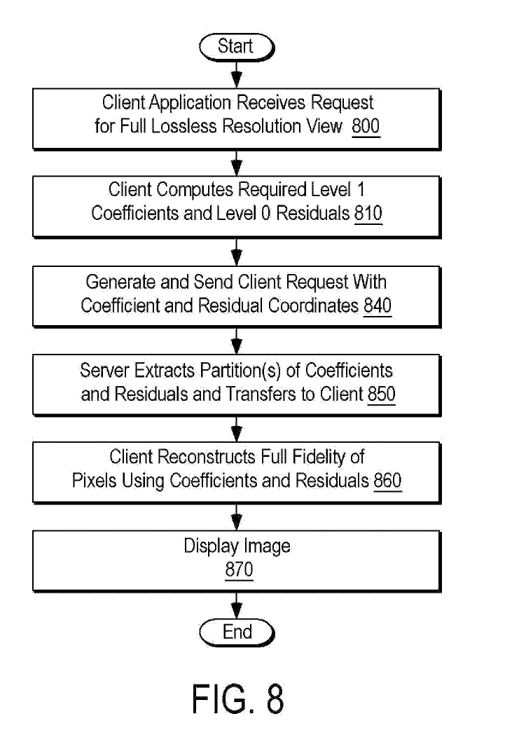

FIG. 8 is a flow diagram illustrating one embodiment for processing client requests for residual data.

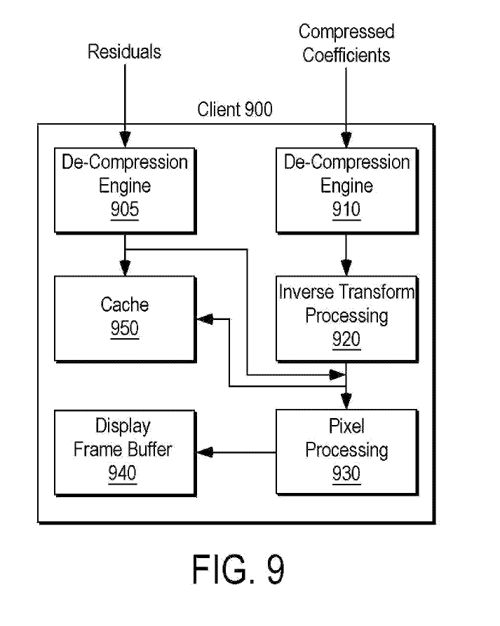

FIG. 9 is a block diagram illustrating one embodiment for reconstructing an image at a client.

As described below in more detail with respect to at least one exemplary embodiment, a “visually lossless” compression technique is used to deliver data in applications with limited bandwidth. In general, the term “visually lossless” refers to an image that has undergone a lossy compression technique but the loss of image information is not perceived by the human eye or the loss is deemed acceptable by the viewer. As described fully below, high quality visually lossless images are generated for rapid dissemination over limited bandwidth networks. Residual data is generated so that completely lossless images (e.g., original lossless images) can be reconstructed from visually lossless images at the client (e.g., a diagnostic station).

The compression techniques of the present disclosure have application for use in imaging, including medical imaging applications (e.g., mammogram, X-Ray, MRI, CATSCAN, etc.).

FIG. 1A is a block diagram illustrating an overview of one exemplary method for processing source data 110. Source data 110 is for example, one or more images, or more specifically, one or more medical images acquired from a modality such as x-ray, CT, or MR or from a medical image archive. The source data 110 is processed for storage on server 100 and distribution over network 180 for display on client computers (150, 160 and 170). The client-server architecture is shown in more detail in FIG. 1B. Server 100 and client computers 150-170 communicate with each other through network interfaces or other communication means for network communication in the server-client architecture.

In FIG. 1A, source data 110 is first input to source data processing 120. Source data processing 120 is either directly on server 100 or on some other computer (not shown) which is accessible by or in communication with server 100. The source data processing 120 comprises software (e.g., computer executable instructions) or hardware such as a dedicated processor with executable processor instructions, or a combination thereof for performing the functions described herein. For example, source data processing 120 comprises software or hardware with executable instructions, or a combination thereof, for generating a compressed hierarchical data representation 240, as described more fully below in conjunction with a discussion of FIG. 2A. The compressed hierarchical data representation 240 is either generated directly on the server 100 or on some other computer (not shown) which is accessible by or in communication with server 100, or is otherwise capable of sharing the compressed hierarchical data representation 240 with the server 100.

Source data processing 120 for generating a compressed hierarchical data representation includes a first step of “decomposition processing”. In general, “decomposition processing” refers to the use of a “transform” to generate a hierarchical representation including coefficients. The coefficients that are generated from the decomposition processing described above, are invertible to the original source data 110. The transform coefficients preserve the data corresponding to a particular area of the image. These transform coefficients along with coefficient coordinates that identify the coefficients in the hierarchical representation are hereinafter referred to collectively as “transform data”. Each level of the generated hierarchical data representation 220 is sufficient to reconstruct the source data at a given resolution. One specific example of decomposition processing is wavelet transform processing 210, which is described in more detail below in connection with FIG. 2A.

Appropriate hardware and software for decomposition processing are described more fully in U.S. Pat. No. 6,711,297, which is incorporated herein by reference. Such hardware and software are herein collectively referred to as decomposition processing means.

Source data processing 120 for generating a compressed hierarchical data representation further comprises software or hardware with executable instructions, or a combination thereof, for partitioning the hierarchical data presentation and quantizing and compressing the coefficients of the hierarchical representation, as described below in more detail in connection with FIG. 2A. Source data processing 120 further comprises software or hardware with executable instructions, or a combination thereof, for generating residual data 280 so as to permit a client to reconstruct completely lossless images from visually lossless images. Such software and hardware are herein collectively referred to as “residual data generation means”. Generation of residual data 280 is described in more detail below in connection with FIG. 2B.

As further shown in FIG. 1A, compressed hierarchical data representation(s) 240 and source residual data 280 are stored in source residual and coefficient data file(s) 400, which are generated by file generation means such as appropriate software, either directly on the server 100 or on another computer. If generated on another computer, server 100 has access to the source residual and coefficient data file(s) 400, or the residual and coefficient data file(s) 400 can otherwise be provided to and/or stored on the server 100. For medical imaging applications, residual and source coefficient data file(s) 400 is a medical image file.

As shown in more detail in FIG. 5, the residual and source data coefficient file(s) 400 include compressed hierarchical data representation(s) (i.e., compressed physical coefficients), organized into partitions, and information to identify the location of levels of the hierarchical transform in the hierarchical data representation(s) as well as information to identify the location of the compressed physical coefficients of the individual partitions within the hierarchical transform levels. The source residual and coefficient data file(s) 400 contain pixel data (i.e., source residual data) to improve a visually lossless version of source data 110 (generated from the compressed physical coefficients), to a lossless version of source data 110, as will be explained in further detail below. As shown in more detail in FIG. 5, the residual and source data coefficient file(s) 400 store information to identify the location of the residual data corresponding to level 0 of the coefficient data, and information to identify the location of the residual data of the individual partitions within level 0.

FIG. 2A illustrates in more detail how the compressed hierarchical data representation(s) 240 is generated as part of source data processing 120. The source data 110 is first processed in wavelet transform processing 210 to generate hierarchical data representation 220. Wavelet transform processing 210 is a form of decomposition processing. More specifically, wavelet transform processing 210 is a form of sub-band decomposition, which consists of separating “high-pass” information from “low-pass” information. In sub-band decomposition, a finite impulse response (“FIR”) filter is used. Either the same or different FIR filters can be used at each stage of the decomposition process resulting in the hierarchical structure illustrated in FIGS. 3A and 3B. One exemplary family of FIR filters to be used is wavelet filters. One preferred wavelet filter to be used is the floating point 5,7 biorthogonal wavelet kernel (Daubechies) specified and used in the JPEG 2000 standard. When such a wavelet system and filter, or similar system and filter, are used, the transform is referred to as a “wavelet transform”.

In the present embodiment, a wavelet transform with preferably floating point kernels, is used to generate a hierarchical data representation 220 consisting of floating point coefficients. The hierarchical data representation 220 can be used at the server 100 to obtain image data from a particular area of an image. A wavelet transform with floating point kernels produces higher quality low resolution image data than a transform with fixed point kernels (for a given filter length). Also, a wavelet transform, with floating point kernels, is used for improved signal to noise ratios in compression applications. Thus, a wavelet transform, with floating point kernels, enables lossy compression at a high signal to noise ratio but at a level that is visually lossless. This approach permits attaining compression ratios for images between 3 and 20 or more to 1, and therefore is suitable for general distribution of images. The relevance of the benefits of a wavelet transform with floating point kernels to compression applications will be better understood from the discussion below of subsequent quantization and compression processing 230.

The related wavelet transform for the decomposition function may be generally defined as:

ŴI=C,

wherein: Ŵ defines the transform function for a transform that utilizes floating point kernels; I represents the source data (e.g., image); and C represents the transformed data (e.g., transformed image).

The use of the wavelet transform to generate the hierarchical data representation provides a scalable solution for transferring different portions of a large data file. When the source data is decomposed into the hierarchical data representation, sub-images and sub-resolution images, in the granularity of partitions of coefficients, can be extracted directly from the disk of the server. The image server then transmits only the physical coefficients required to reconstruct the exact size of the desired image for display at the client. Accordingly, a multi-resolution format is implicit in the hierarchical data representation.

The wavelet transform function generates mathematically independent information among the levels of the hierarchical representation. Accordingly, there is no redundant information in the hierarchical data representation. Thus, hierarchical data representation is not merely multiple replications of the source data at different resolutions, but it contains unique data at the different levels of the hierarchical representation. The mathematically independent nature of the wavelet transform permits minimizing the amount of data transferred over a network, by requiring only the transfer of “additional data” not yet transferred to the computer from the server necessary to construct a given image. The wavelet transform is lossless, in that no data from the original source data is lost in the decomposition into the hierarchical data representation.

In other embodiments, the wavelet transform may be used to generate multi-spectral (e.g., color) transform data. In general, multi-spectral transform data aggregates multiple components of the source image into a vector for the transform data. Also, the multi-spectral transform data may comprise any type of attribute for binding to the source data.

A “wavelet transform” has been described herein by example only for the purpose of providing a full and detailed written description of at least one specific embodiment. Decomposition processing is not by any means limited to wavelet transform processing and related wavelet filters and methods. Other methods for decomposition processing can be used which would be known or understood by one having ordinary skill in the art or which would inherently fall within the scope or spirit of this disclosure.

In general, to generate the hierarchical data representation 220, the wavelet transform is applied across the columns of the source data 110, and then this wavelet transform is applied across the rows of the source data 110 (i.e., or vice versa). The selection of the wavelet transform for wavelet transform processing 210 is dependent upon the particular characteristics of the hierarchical data structure desired. Each level of the hierarchical data structure is generated by recurring on the low-pass, “low low”, of the previous higher level. This recursion continues until a predetermined size is obtained. For example, in one embodiment, the lowest level in the hierarchical data structure for a source image consists of a low-pass component of approximately 128×128. However, any granularity of resolution may be generated for use in a hierarchical data structure without deviating from the spirit or scope of the invention. Also, any quadrant may be used in the recursion process with any desired transform.

FIG. 3A illustrates an example of a hierarchical data representation 220 of FIG. 2A. For this example, the source image comprises a 4K×4K image. The source data processing 120 generates, in a first iteration, a level one Mallat (separable transform) structure. Specifically, as shown in FIG. 3A, a low-pass component, “low low”, is generated and consists of a 2K×2K sub-image. The high-pass components, consisting of “low high”, “high high”, and “high low”, contain physical coefficient coordinates (e.g., the upper right hand coordinate for the rectangle that constitutes the “low high” component is (4K, 0)).

FIG. 3A also illustrates a second level decomposition of an image. The second iteration of source data processing 120 operates on the low pass (i.e., “low low”), component of the level one data. For the second level, the low-pass component, “low low”, consists of a 1K×1K sub-image, as labeled in FIG. 3A. FIG. 3B illustrates level three and level four decompositions for the 4K×4K source image of FIG. 3A. To generate the level three decomposition, source data processing 120 operates on the level two “low low” component (i.e., the 1K×1K image). For the level three transform, the low-pass component, “low low”, is a 512×512 sub-image as labeled on FIG. 3A. FIG. 3B also illustrates a fourth level of decomposition for the 4K×4K source image. For the level four transform, the low-pass component comprises a sub-image of 256×256 pixels.

Turning back to FIG. 2A, after the source data is decomposed into the hierarchical data representation(s) 220, the transform data is partitioned in partition processing 222 to generate blocks of transform data, or partitioned transform data. Partitioning transform data is described in U.S. Pat. No. 6,925,208, which is incorporated herein by reference. In the present embodiment, each level of the hierarchical data representation, above level “n”, is organized into 64×64 coefficient partitions or blocks, which is described more fully below in conjunction with a discussion of FIG. 4. However, other alternative schemes for partitioning transform data may be used which are understood to one having ordinary skill in the art or which are inherently within the scope or spirit of this disclosure).

The partitioned transform data is quantized and compressed in quantization and compression processing 230 (FIG. 2A) via appropriate quantization and compression means in the form of software for example, to generate compressed hierarchical data representations 240 (FIG. 2A). In one embodiment, to compress the transform data, the coefficients for a block of data are quantized by a floating point value. The result is truncated towards zero and stored as an integer. A block of coefficients is quantized by quantization bin widths, Q, for example. In the present embodiment, there is one quantization bin width per coefficient block, but any number of quantization bin widths can be used. Generally, this operation may be expressed as:

\hat{Q}ŴI=\hat{Q}R,

wherein, R represents a block of coefficients in the transform data, and \hat{Q} represents the quantized function. For this expression, if truncation toward zero is used, the quantization function may be expressed as follows.
If (R>0), then

$${R}_{Q} = \frac{R + .5 Q}{Q}$$

else, (i.e., if R<0),

$${R}_{Q} = \frac{R - .5 Q}{Q}$$

wherein, Q is a floating point value and the resultant is consistently truncated (i.e., either towards or away from zero), such that R_{Q} is a multiple of the quantization bin width, Q.

The coefficients can be quantized in accordance with the corresponding level of the decomposition. Thus, for this embodiment, there is one quantization bin width, Q, for each level, but any number of quantization bin widths could be used. For this embodiment, the quantization values may be quantized as follows:

$${R}_{L 1}^{Q} = \frac{R ( Level 1 )}{Q 1}$$

$${R}_{L 2}^{Q} = \frac{R ( Level 2 )}{Q 2}$$

$${R}_{L 3}^{Q} = \frac{R ( Level 3 )}{Q 3}$$

$${R}_{LN}^{Q} = \frac{R ( Level N )}{Q N}$$

wherein, “L” and “Level” represent the level of the decomposition for the “N” level example, and Q1, Q2, Q3 and QN represent quantization bin widths for the respective levels. Although the above expression represents quantization based on levels of the decomposition, any combination of different quantization values may be used to quantize a set of coefficients without deviating from the spirit or scope of the invention.

Also, in a further scenario where coefficients are quantized based on the level of the decomposition, the high pass coefficients may be aggregated into a quantized coefficient block as follows:

$${R}_{Level 1}^{Q} = \frac{R ( LH + HL + HH )}{Q 1}$$

$${R}_{Level 2}^{Q} = \frac{R ( LH + HL + HH )}{Q 2}$$

$${R}_{Level 3}^{Q} = \frac{R ( LH + HL + HH )}{Q 3}$$

$${R}_{Level N}^{Q} = \frac{R ( LH + HL + HH )}{Q N}$$

Accordingly, for this example, the high-energy components for each coefficient block of the transform are quantized for compression processing. Although the above example quantizes components of the transform, any block of transform data may be quantized for subsequent compression.

The quantized coefficient block, R^{Q}, is compressed to generate the transmission coefficient block in accordance with the expression:

R^{T}=ÊR^{Q};

wherein, Ê defines the compression expression, and R^{T} defines the compressed coefficient block for transmission. In general, the compression function, Ê, comprises a lossless coder. Any encoding rule may be used for the compression function, Ê, without deviating from the spirit or scope of the invention. For example, the compression function, Ê, may be implemented with a Rice encoding function or a Huffman encoding function, with or without run length encoding, arithmetic encoding, etc. As one example, the low low (“LL”) component of a level is encoded using Rice encoder, and quantized data (which typically include runs of zeros) is encoded using an arithmetic encoder.

As described more fully below, the compressed coefficient block, R^{T}, is transmitted to the client. At the client, the inverse quantization and decoder functions are executed. This operation may be expressed as:

R=\hat{Q}⁻¹Ê⁻¹R_{T}.

The inverse transform, Ŵ⁻¹ is performed on the coefficients, R (and any additionally required data already at the client), to generate the original data.

FIG. 2B illustrates source data processing 120 for generating residual pixel data 280. The compressed hierarchical data representation 240, generated in accordance with the block diagram of FIG. 2A, is processed by inverse wavelet transform processing 246. In general, inverse wavelet transform processing 246 performs the inverse of the wavelet transform executed in wavelet transform processing 210 (FIG. 2A). The output of inverse wavelet transform processing 246 is inverted visually lossless pixel data 254. To generate the residual pixel data, the inverted visually lossless data 254 is subtracted from the original source data 110 in subtraction block 262 to generate the residual pixel data 280.

In the present embodiment, the coefficients and residual data are organized in partitions. FIG. 4 illustrates organizing a level of a hierarchical data representation of coefficients in partitions. For this example, the coefficients are organized into 64×64 coefficient partitions. Each level of the hierarchical data representation above level “n” is organized into partitions (e.g., levels 0, 1, 2 and 3 for the example shown in FIGS. 3A and 3B). For this example, the coefficients in the high pass components of level 4 (e.g., low-high (LH), high-low (HL), and high-high (HH)) are each partitioned into 16 partitions (i.e., 256×256 coefficients per component). Although the example of FIG. 4 is shown as partitioning coefficients into 64×64 coefficient blocks, any partition size may be used without deviating from the spirit or scope of the invention. In alternative embodiments, different levels may use different sized partitions. For example, the residual partitions at level 0 may be twice the row and column dimensions as the level 1 coefficient partitions.

As shown in FIG. 4, each partition is uniquely identified. The group of partitions for the LH component labeled 200 in FIG. 4, are identified as partitions P₀₁-P₁₅₁. Similarly, the group of partitions for the HH component 212 is identified as partitions P₀₂-P₁₅₂, and the group of partitions for the HL component 222 is identified as partitions P₀₃-P₁₅₃. The coefficient blocks are organized in a file format as shown in blocks 232 and 242 of FIG. 4. For this example, the file format organizes the compressed coefficient data by grouping corresponding partitions and accompanying compressed coefficient data from the LH, HH, and HL components. Thus, for this example, to store this level of compressed coefficient data, partition P₀₁ from the LH component is followed by partition P₀₂ from the HH component and subsequently by partition P₀₃ from the HL component. Similarly, partition P₁₁ from the LH component is followed by partition P₁₂ from the HH component and subsequently by partition P₁₃ from the HL component.

FIG. 5 illustrates a source residual and coefficient data file 400 according to the present embodiment. Source data file 400 includes a file header 410. The file header 410 includes general information about the source data file 400, as well as pointers to locations that identify data for levels within the source data file 400. For this embodiment, the file header 410 specifies: a byte order, version, format of image, compressed partitions/residual data, the number of rows, columns, and levels for the corresponding source data, the location of the level offsets, the coefficient checksum, and header checksum. The format of the image may comprise any number of suitable formats for storing images. For example, the image format may include monochrome, luminance/chrominance representations, as well as various types of encoding schemes (e.g., RLE, JPEG, etc.)

As shown in FIG. 5, file header 410 includes addresses to identify locations in the file for each individual level. For this example, level 0[addr] points to a location (offset) in source data file 400 for the start of data pertaining to level 0 (the level 0 data contains the residual data partitions), level 1 [addr] points to the starting location in source data file 400 for level 1 data (the level 1 data contains the coefficient partitions and corresponds with coefficient blocks 232 in FIG. 4 for a given transform level), etc. As shown in FIG. 5, data for level 0 contains the number of residual partitions contained in level 0 and offsets to each individual residual partition. The offsets to the partitions identify the starting address for the residual data in that partition. For example, the partition0[offset] points to Partition 0 residual data (i.e., the residuals for partition 0 in level 0). For this embodiment, data for levels greater than 0 (i.e., level 1-level n), includes, in addition to the coefficient data, the number of partitions contained in the corresponding level and offsets to each individual partition. The offsets to the partitions identify the starting address for the coefficients in that partition. For example, the partition0[offset] in level 2 points to Partition 0 coefficient data (i.e., the coefficients for partition 0 in level 2). Accordingly, the source data file 400 provides locations for each partition by identifying the level and the partition offset within the level for the coefficient data (levels 1-n) or the residual data (level 0). As shown in FIG. 5, coefficient data of level “n” is not partitioned, though there is no reason that it could not also be partitioned. The source data file 400 permits the server to directly memory map the source data file 400.

FIG. 6B is a block diagram illustrating one example for implementing the compression techniques in a client-server environment. A server 100 is coupled, via a network, to one or more clients (e.g., clients 150 and 160). Source data is decomposed on either the server 100, or another computer (not shown) into a hierarchical data representation(s) incorporating “n” levels. The hierarchical data representation is quantized and compressed on either the server 100 or another computer. In either case, the compressed hierarchical data representation(s) is accessible by the server 100. As shown in FIG. 6A, each level of the compressed coefficients are organized into partitions (e.g., level 1 has “X” partitions, level 2 has “Y” partitions, level 3 has “Z” partitions, level 4 has “AA” partitions, and level 5 has “BB” partitions). Residual data for level 0 is also stored. The compressed coefficients and residual data are stored in a permanent storage medium, such as one or more hard disk drives in server 100.

During set up of a communications protocol between the server and the client, the client may specify one or more source data or images (i.e., compressed coefficients) for the subsequent client request—server transfer process. In one embodiment, the server-client implements “event” communication services offered through the Common Object Request Broker Architecture (“CORBA”). However, any network protocol may be used to implement client—server network communications without deviating from the spirit or scope of the invention.

As further shown in FIG. 6B, data is transferred from the server 100 to a client upon the initiation of client requests. Specifically, a client generates a request that identifies one or more partitions of compressed coefficients for source data (e.g., a source image). For this example, client 150 generates requests for compressed coefficient partitions corresponding to the desired portion of source data 110. The client generates a request that defines partitions of coefficient coordinates sufficient to reconstruct, at the client, the desired portion of the source data 110. The client request for coefficients includes an image ID and a designation of requested compressed coefficient partitions. The image ID identifies an image that is being requested. The designation of requested partitions identifies one or more levels in the hierarchical data representation in the source data file 400 as well as one or more corresponding requested partitions within the levels.

In response to the request, the server 100 extracts the partitions of compressed coefficients from the source data file 400, identified in the request, and transfers the compressed partitions of coefficients to the client 150. Thereafter, the client 150 can reconstruct a visually lossless version of the portion of the image using the compressed partitions of coefficients. Reconstruction is achieved through software (e.g., computer executable instructions), hardware such as a dedicated processor with executable processor instructions, or a combination thereof, operating on client 150 for performing the functions described herein. Such software and hardware are herein collectively referred to as visually lossless image reconstruction means.

If the client desires a full fidelity or completely lossless version of a portion of a source image stored at a client and the client has level 1 coefficient data, the client generates a request for partitions of residual data for that portion of the image, including image identification and pixel coordinates. Client 160 generates requests for residual data for level 0 coefficients. The server 100, in response to the request, extracts the partitions of residual pixel data for level 0, and transfers the residual data to client 160. In turn, the client 160 reconstructs the portion of the image, at full fidelity (a completely lossless version of the portion of the image), using the previously generated pixel data and the residual pixel data. Reconstruction is achieved through software (e.g., computer executable instructions) or hardware such as a dedicated processor with executable processor instructions, or a combination thereof, operating on client 160 for performing the functions described herein. Such software and hardware are herein collectively referred to as completely lossless image reconstruction means.

FIG. 7 is a flow diagram illustrating a method for processing client requests for partitions of compressed coefficients. A client application operates on a client computer and requires the display of source data, such as images. The process is initiated when the client application generates pixel coordinates at a desired resolution for an image (500, FIG. 7). The client computes the partitions of compressed coefficients required to generate a portion of the image, specified by the pixel coordinates, at the desired resolution (520, FIG. 7). If the coefficients are not cached at the client, then the client formulates a request for required partition(s) of compressed coefficients (530 and 540, FIG. 7). The request is transmitted to the server. The server extracts partition(s) of compressed coefficients from the source data file 400 corresponding to a desired portion of the image file, and the partitions of compressed coefficients are transferred to the client (550, FIG. 7). The client then decompresses the compressed coefficients (555, FIG. 7). If the coefficients are cached at the client (530, FIG. 7), or the client has decompressed the compressed coefficients, then the client reconstructs the image from the partition(s) of coefficients (560, FIG. 7). The reconstructed image is displayed at the client in response to the user request. (570, FIG. 7).

FIG. 8 is a flow diagram illustrating a method for processing client requests for residual data. For this embodiment, the client stores image data, generated from the compressed coefficients, and/or stores compressed coefficients for at least portions of a source image. The client application receives a request for a completely lossless resolution view (800, FIG. 8). The client computes the required partitions of level 1 compressed coefficients and level 0 residual data from the pixel coordinates of the source image (810, FIG. 8). As discussed above, the client specifies additional pixels to handle edge effects. In response to the request, the server extracts partition(s) of level 1 compressed coefficients and partition(s) of level 0 residual pixel data, and transfers the compressed coefficients and residual pixel data to the client (850, FIG. 8). Using the compressed coefficient and residual data, the client reconstructs the full fidelity of the image (i.e., a completely lossless image) using the previously generated pixel data and the residual pixel data (860, FIG. 8). The client then displays the completely lossless image (870, FIG. 8).

FIG. 9 is a block diagram illustrating a method for reconstructing a completely lossless image from a visually lossless image at a client. The client receives compressed coefficients at the decompression engine 910. The decompression engine 910 generates coefficients from the compressed coefficients. Inverse transform processing 920 performs an inverse transform to generate pixel data from the coefficients. The pixel data is cached in cache 950. Pixel processing 930 generates pixel data for frame buffer 940 and for display at the client. The residual data, after decompression in decompression engine 905, is received at pixel processing 930. To reconstruct the full fidelity or completely lossless image, pixel processing 930 aggregates pixel data generated from the coefficients and the residual pixel data for display frame buffer 940.

Those of skill would further appreciate that the various illustrative logical blocks, modules and algorithm steps described in connection with the embodiments disclosed herein may be implemented as electronic hardware, computer software, or combinations of both. To clearly illustrate this interchangeability of hardware and software, various illustrative components, blocks, modules and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks and modules described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, (e.g., a combination of a DSP and a microprocessor, a plurality of microprocessors, one or more microprocessors in conjunction with a DSP core, or any other such configuration).

Although the present invention has been described in terms of specific exemplary embodiments, it will be appreciated that various modifications and alterations might be made by those skilled in the art without departing from the spirit and scope of the invention.

What is claimed is:

1. A method for transferring image data from a server to at least one client, said method comprising:
generating a compressed hierarchical representation of said image data, said compressed hierarchical representation comprising a plurality of compressed coefficients;
generating residual data that corresponds to said compressed coefficients, said compressed coefficients and said residual data being sufficient to reconstitute at least a portion of said image data without loss of data;
transferring, from said server to said client, said compressed coefficients and said residual data;
re-constructing, at said client, a visually lossless version of said portion of said image data for display at said client using said compressed coefficients; and
re-constructing, at said client, a completely lossless version of said portion of said image data for lossless display at said client using said residual data.

2. The method as set forth in claim 1, wherein said transferring of said compressed coefficients and said residual data from said server to said client is initiated by said client transmitting a request to said server for said compressed coefficients and residual data.

3. The method as set forth in claim 1, wherein said compressed hierarchical representation and said residual data are generated on said server or on a computer readable medium remotely accessible by said server.

4. The method as set forth in claim 1, wherein said compressed hierarchical representation is generated from said image data using a wavelet transform with floating point kernels.

5. The method as set forth in claim 1, further comprising:
transmitting from said client to said server a request for additional compressed coefficients of said compressed hierarchical representation necessary to reconstruct a new portion of said image from a combination of previously transferred compressed coefficients and said additional compressed coefficients;
transferring, from said server to said client, said additional compressed coefficients from said hierarchical representation, corresponding to said new portion of said image data; and
reconstructing said new portion of said image data with said additional compressed coefficients and said compressed coefficients previously transferred.

6. The method as set forth in claim 5, further comprising:
transmitting, from said client to said server, a request for residual data for said new portion of said image data;
transferring, from said server to said client, residual data, corresponding to said new portion of said image data; and
reconstructing said new portion of said image data from said additional compressed coefficients, said compressed coefficients originally transferred, and said residual data.

7. The method as set forth in claim 1, wherein generating residual data comprises:
performing an inverse wavelet transform on said compressed coefficients to generate inverted visually lossless data; and
generating said residual data from a difference between said inverted visually lossless data and said image data.

8. The method as set forth in claim 1, wherein generating a compressed hierarchical representation comprises:
performing a wavelet transform on said image data, using floating point kernels, to generate a hierarchical representation of coefficients;
quantizing said hierarchical representation of coefficients; and
compressing said hierarchical representation of coefficients.

9. The method as set forth in claim 1, further comprising:
partitioning said compressed coefficients into a plurality of partitions of compressed coefficients;
transmitting, from said client to said server, a request for at least one partition of said compressed coefficients; transferring, from said server to said client, the requested at least one partition of compressed coefficients; and
reconstructing the image data at the client from said compressed coefficients.

10. The method as set forth in claim 9, further comprising:
partitioning said residual data into a plurality of partitions of residual data;
transmitting, from said client to said server, a request for at least one partition of said residual data;
transferring, from said server to said client, said requested partition of residual data; and
re-constructing said completely lossless version of said portion of said image data with said requested partition of residual data.

11. A computer readable medium for use by a computer, said medium comprising a plurality of instructions executable to perform the functions of:
generating a compressed hierarchical representation of said image data, said compressed hierarchical representation comprising a plurality of compressed coefficients;
generating residual data that corresponds to said compressed coefficients, said compressed coefficients and said residual data being sufficient to reconstitute at least a portion of said image data without loss of data;
generating a file for storing said compressed hierarchical representation and said residual data, said file being accessible to a server for transfer of said compressed coefficients and said residual data to a client, wherein said compressed coefficients are usable by said client for re-constructing a visually lossless version of said portion of said image data for display at said client, and said residual data is usable by said client for re-constructing a fully lossless version of said portion of said image data for lossless display at said client.

12. The computer readable medium as set forth in claim 11, wherein said image data is medical image data.

13. The computer readable medium as set forth in claim 11, wherein said compressed hierarchical representation is generated from said image data using a wavelet transform with floating point kernels.

14. The computer readable medium as set forth in claim 11, wherein generating residual data comprises:
performing an inverse wavelet transform on said compressed coefficients to generate inverted visually lossless data; and
generating said residual data from a difference between said inverted visually lossless data and said image data.

15. The computer readable medium as set forth in claim 11, wherein generating a compressed hierarchical representation comprises:
performing a wavelet transform on said image data, using floating point kernels, to generate a hierarchical representation of coefficients;
quantizing said hierarchical representation of coefficients; and
compressing said hierarchical representation of coefficients.

16. The computer readable medium as set forth in claim 11, further comprising instructions for partitioning said compressed coefficients into a plurality of partitions of compressed coefficients.

17. The computer readable medium as set forth in claim 16, further comprising instructions for partitioning said residual data into a plurality of partitions of residual data.

18. A system for transferring image data comprising:
a server for storing a compressed hierarchical representation of said image data, said compressed hierarchical representation comprising a plurality of compressed coefficients, and for storing residual data that corresponds to said compressed coefficients, said compressed coefficients and said residual being sufficient to reconstitute at least a portion of said image data without loss of data;
at least one client for receiving said compressed coefficients for re-constructing a visually lossless version of said portion of said image data for display at said client, and for receiving said residual data for re-constructing, at said client, a fully lossless version of said portion of said image data for lossless display at said client
a network for facilitating transfer of said compressed coefficients and said residual data from said server to said at least one client.

19. The system as set forth in claim 18, wherein:
said client is further capable of transmitting a request, to said server, for additional compressed coefficients from said compressed hierarchical representation necessary to reconstruct a new portion of said image data from a combination of previously transferred compressed coefficients and said additional compressed coefficients; and
said server is further capable of transferring, to said client over said network, said requested additional compressed coefficients from said hierarchical representation, corresponding to said new portion of said image data.

20. A system for transferring images from a server to a client, comprising:
decompression processing means for generating a compressed hierarchical representation of said image data which is accessible by said server, said compressed hierarchical representation comprising a plurality of compressed coefficients;
residual data generation means for generating residual data that corresponds to said compressed coefficients and which is accessible by said server, said compressed coefficients and said residual data being sufficient to reconstitute at least a portion of said image data without loss of data;
communication means for transferring, from said server to said client, said compressed coefficients and said residual data;
first reconstruction means for re-constructing, at said client, a visually lossless version of said portion of said image data for display at said client using said compressed coefficients; and
second reconstruction means for re-constructing, at said client, a fully lossless version of said portion of said image data for lossless display at said client using said residual data.

21. The system according to claim 20, wherein said residual data generation means for generating residual data operates by performing an inverse wavelet transform on said compressed coefficients to generate inverted visually lossless data and generates said residual data from a difference between said inverted visually lossless data and said image data.

22. The system according to claim 20, wherein one of either the server or a computer readable medium remotely accessible by said server, comprises said decompression processing means and said residual data generation means.
